(19) United States
(12) Patent Application Publication
(10) Pub. No.: US 2025/0069192 A1
(43) Pub. Date: Feb. 27, 2025

(54) VIDEO DISPLAY METHOD AND APPARATUS, AND ELECTRONIC DEVICE

(71) Applicant: Beijing Zitiao Network Technology Co., Ltd., Beijing (CN)

(72) Inventor: Shengru WANG, Beijing (CN)

(21) Appl. No.: 18/723,397

(22) PCT Filed: Dec. 22, 2022
(86) PCT No.: PCT/CN2022/140872

§ 371 Date: Jun. 21, 2024

(30) Foreign Application Priority Data
Dec. 23, 2021 (CN) 202111589868.6

(51) Int. Cl. G06T 5/50; G06T 1/60; G06T 3/40; G06T 7/10; G06V 10/44

(52) U.S. Cl. CPC G06T 5/50; G06T 1/60; G06T 3/40; G06T 7/10; G06V 10/44; G06T 2207/20221

(57) ABSTRACT

The present disclosure relates to a video display method and apparatus, and an electronic device, and particularly relates to the technical field of image processing. The method comprises: displaying a first image; and in response to an input for the first image, displaying a first video, the first video comprising a plurality of consecutive second image frames, so as to present a target object image acquired in real time and a dynamic effect of a local feature in the first image, wherein each second image frame comprises the target object image and a partial image of a third image and, and the third image is one of a plurality of consecutive target image frames that are obtained after the local feature in the first image is processed.

### CROSS-REFERENCE TO RELATED APPLICATIONS

The present application claims priorities from PCT application No. PCT/CN2022/140872 filed on Dec. 22, 2022, and the Chinese patent application No. 202111589868.6, entitled “VIDEO DISPLAY METHOD AND APPARATUS, AND ELECTRONIC DEVICE”, filed on Dec. 23, 2021, both of which are hereby incorporated by reference in their entirety.

### TECHNICAL FIELD

The present disclosure relates to the technical field of image processing and, in particular, to a video display method and apparatus, and an electronic device.

### BACKGROUND

Currently, when fused video recording with an image acquired by a user in real time through a camera and a static image, if the user wants to acquire more dynamic effects during the fused video recording, there is an urgent need for a video display method capable of concurrently presenting the dynamic effects of the static image, and the real-time image acquired by the camera.

### SUMMARY

The present disclosure provides a video display method that, in fused video recording scenarios, is able to concurrently present a target object image acquired in real time and a dynamic effect of a local feature in a static image.

The technical solutions provided in embodiments of the present disclosure are as follows.

According to a first aspect, there is provided a video display method, comprising:
displaying a first image; and
in response to an input for the first image, displaying a video including a plurality of consecutive frames of second images, to present a target object image acquired in real time and a dynamic effect of a local feature in the first image;
wherein each frame of the second images includes the target object image and a partial image of a third image, the third image being one frame of a plurality of consecutive frames of target images obtained after processing the local feature in the first image.

As an optional embodiment of the embodiments of the present disclosure, the method further comprises:
acquiring the first image;
processing the local feature of the first image using a Generative Adversarial Networks (GAN) algorithm, to obtain the plurality of consecutive frames of target images;
acquiring the third image to be displayed from the plurality of consecutive frames of target images;
acquiring the target object image from an image acquired by a camera in real time; and
fusing the third image with the target object image to obtain one frame of the second images.

As an optional embodiment of the embodiments of the present disclosure, the processing the local feature of the first image using the GAN algorithm to obtain the plurality of consecutive frames of target images comprises:
processing the local feature of the first image using the GAN algorithm, to obtain a plurality of consecutive frames of local feature images; and
respectively fusing the first image with each of the plurality of consecutive frames of local feature images to obtain the plurality of consecutive frames of target images.

As an optional embodiment of the embodiments of the present disclosure, prior to the fusing the third image with the target object image to obtain one frame of the second images, the method further comprises:
in accordance with the image acquired by the camera in real time, determining a mask image in which a first mask region corresponding to the target object image is identified;
the acquiring the target object image from the image acquired by the camera in real time, comprising:
in accordance with the mask image and the image acquired by the camera in real time, acquiring the target object image from the image acquired by the camera in real time;
the fusing the third image with the target object image to obtain one frame of the second images, comprising:
in accordance with the mask image and the third image, acquiring, from the third image, a partial image of the third image that matches mask regions other than the first mask region; and
in accordance with the target object image and the partial image of the third image, forming the one frame of the second images by fusion.

As an optional embodiment of the embodiments of the present disclosure, in the mask image, the first mask region is identified by a target color channel;
wherein the target color channel is any one of an R channel, a G channel and a B channel.

As an optional embodiment of the embodiments of the present disclosure, the acquiring the third image to be displayed from the plurality of consecutive frames of target images comprises:
acquiring one frame of the target images to be displayed from the plurality of consecutive frames of target images;
in accordance with an aspect ratio of the one frame of target images and a screen aspect ratio, constructing a Model View Projection (MVP) matrix; and
in accordance with the MVP matrix, scaling the one frame of the target images to obtain the third image.

As an optional embodiment of the embodiments of the present disclosure, the method further comprises:
acquiring a second image;
processing the second image using the GAN algorithm, to obtain and cache a plurality of consecutive frames of processed images;
subsequent to the acquiring the first image, the method further comprising:
in response to determining that the first image is different from the second image, clearing the cache.

According to a second aspect, there is provided a video display apparatus, comprising:
a display module for displaying a first image; and in response to an input for the first image, displaying a video including a plurality of consecutive frames of second images, to present a target object image acquired in real time and a dynamic effect of a local feature in the first image;
wherein each frame of the second images includes the target object image and a partial image of a third image, the third image being one frame of a plurality of consecutive frames of target images obtained after processing the local feature in the first image.

As an optional embodiment of the embodiments of the present disclosure, the apparatus further comprises:
an acquisition module for acquiring the first image; and
a processing module for processing the local feature of the first image using a GAN algorithm to obtain the plurality of consecutive frames of target images;
the acquisition module further used to acquire the third image to be displayed from the plurality of consecutive frames of target images;
the processing module further used to acquire the target object image from an image acquired by a camera in real time; and
the processing module further used to fuse the third image with the target object image to obtain one frame of the second images.

As an optional embodiment of the embodiments of the present disclosure, the processing module is specifically used to:
process the local feature of the first image using the GAN algorithm, to obtain a plurality of consecutive frames of local feature images; and
respectively fuse the first image with each of the plurality of consecutive frames of local feature images to obtain the plurality of consecutive frames of target images.

As an optional embodiment of the embodiments of the present disclosure, the processing module is further used to:
in accordance with the image acquired by the camera in real time, determine a mask image in which a first mask region corresponding to the target object image is identified; and
the processing module is specifically used to:
in accordance with the mask image and the image acquired by the camera in real time, acquire the target object image from the image acquired by the camera in real time;
in accordance with the mask image and the third image, acquire, from the third image, a partial image of the third image that matches mask regions other than the first mask region; and
in accordance with the target object image and the partial image of the third image, form the one frame of the second images by fusion.

As an optional embodiment of the embodiments of the present disclosure, in the mask image, the first mask region is identified by a target color channel;
wherein the target color channel is any one of an R channel, a G channel and a B channel.

As an optional embodiment of the embodiments of the present disclosure, the acquisition module is specifically used to:
acquire one frame of the target images to be displayed from the plurality of consecutive frames of target images;
in accordance with an aspect ratio of the one frame of target images and a screen aspect ratio, construct a Model View Projection (MVP) matrix; and
in accordance with the MVP matrix, scale the one frame of the target images to obtain the third image.

In an optional embodiment as the embodiments of the present disclosure, the acquisition module is further used to acquire a second image;
the processing module is further used to process the second image using the GAN algorithm, to obtain and cache a plurality of consecutive frames of processed images; and
the acquisition module is further used to: in response to determining that the first image is different from the second image, clear the cache.

According to a third aspect, there is provided an electronic device, comprising: a memory, a processor, and a computer program stored on the memory and executable on the processor that, when executed by the processor, implements the video display method, apparatus and electronic device according to the first aspect or any one of the optional embodiments thereof.

According to a fourth aspect, there is provided a computer readable storage medium, comprising: a computer program stored on the computer readable storage medium that, when executed by a processor, implements the video display method, apparatus and electronic device according to the first aspect or any one of the optional embodiments thereof.

According to a fifth aspect, there is provided a computer program product, comprising computer readable instructions that, when executed by a processor, implements the video display method, apparatus and electronic device according to the first aspect or any one of the optional embodiments thereof.

According to a sixth aspect, there is provided a computer program, comprising computer readable instructions that, when executed by a processor, implements the video display method, apparatus and electronic device according to the first aspect or any one of the optional embodiments thereof.

### DESCRIPTION OF THE DRAWINGS

The drawings here are incorporated into the description and form part of the description, showing embodiments consistent with the present disclosure, and are used together with the description to explain the principles of the present disclosure.

In order to more clearly illustrate the embodiments of the present disclosure or technical solutions in related art, a brief introduction will be given below for the drawings that need to be used in the description of the embodiments or related art. It is obvious that, for a person of ordinary skill in the art, he or she may also obtain other drawings according to such drawings, without spending any inventive effort.

FIG. 1 is a first flow chart illustrating a video display method provided in an embodiment of the present disclosure.

FIG. 2 is a schematic diagram of an interface of an electronic device for displaying a static character image provided in an embodiment of the present disclosure.

FIG. 3 is a schematic diagram of displaying a plurality of frames of images in a video provided in an embodiment of the present disclosure.

FIG. 4 is a second flow chart illustrating a video display method provided in an embodiment of the present disclosure.

FIG. 5 is a block diagram of a video display apparatus provided in an embodiment of the present disclosure.

FIG. 6 is a schematic diagram of an electronic device provided in an embodiment of the present disclosure.

### DETAILED DESCRIPTION OF THE EMBODIMENTS

In order that the objects, features and advantages of the present disclosure may be more clearly understood, the solutions of the present disclosure will be further described below. It is to be noted that, without confliction, the embodiments of the present disclosure and the features in the embodiments can be combined with each other.

For a more complete understanding of the present disclosure, many details are illustrated hereinbelow. However, the present disclosure may also be implemented by manners different than those as described here. Obviously, the embodiments in the description are just a part, instead of all, of the embodiments of the present disclosure.

Currently, when fused video recording with an image acquired by a user in real time through a camera and a static image, if the user wants to acquire more dynamic effects during the fused video recording, there is an urgent need for a video display method that can concurrently present the dynamic effects of the static image, and the real-time image acquired by the camera.

In order to solve the above problem, the embodiments of the present disclosure provide a video display method and apparatus, and an electronic device capable of presenting a target object image acquired in real time and a dynamic effect of a local feature in a first image, thereby concurrently presenting the real-time image acquired by the camera and the dynamic effect of the static image.

The video display method provided in the embodiments of the present disclosure may be implemented by a video display apparatus and an electronic device, wherein the video display apparatus may be a functional module or functional entity in the electronic device for implementing the video display method.

The above electronic device may be a tablet computer, a mobile phone, a laptop computer, a palmtop computer, an on-vehicle terminal, a wearable device, etc., which is not specifically limited in the embodiments of the present disclosure.

The technical solutions provided in the embodiments of the present disclosure have the following advantages over the related art: by an input for a first image, which is a static image, it is possible to trigger the display of a video including a plurality of consecutive frames of second images, and since each frame of the second images includes a target object image and a partial image of a third image (one frame of a plurality of consecutive frames of target images obtained by processing the local feature in the first image), it is possible to present the dynamic effect of the local feature in the first image and the target object image acquired in real time by displaying the video, thereby concurrently presenting the dynamic effect of the static image, as well as the real-time image acquired by a camera.

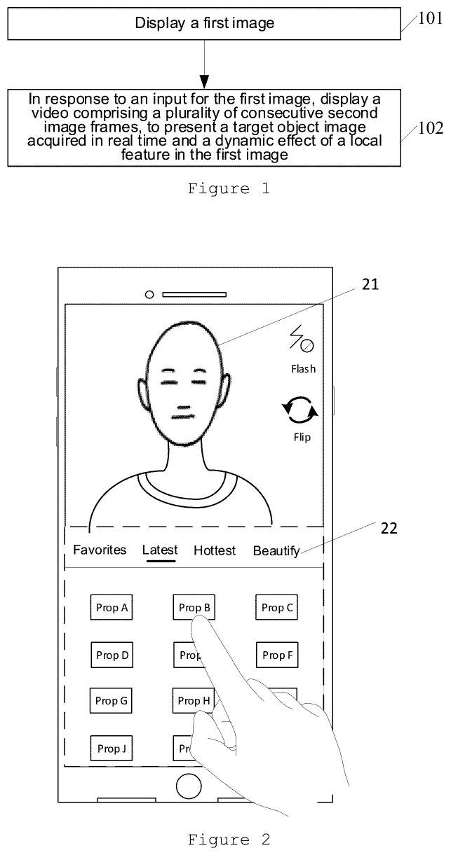

FIG. 1 shows a flow chart of a video display method, the method comprising:
101: displaying a first image.

In the embodiments of the present disclosure, the first image may be an image including some local features, and these local features may vary somewhat in actual scenarios. For example, the first image can be an image that includes facial features of a human, which typically vary with facial expressions in real life. As another example, the first image can be an image that includes hair, which typically appears to change in fluidity as a person's head moves, or as a result of air flow.

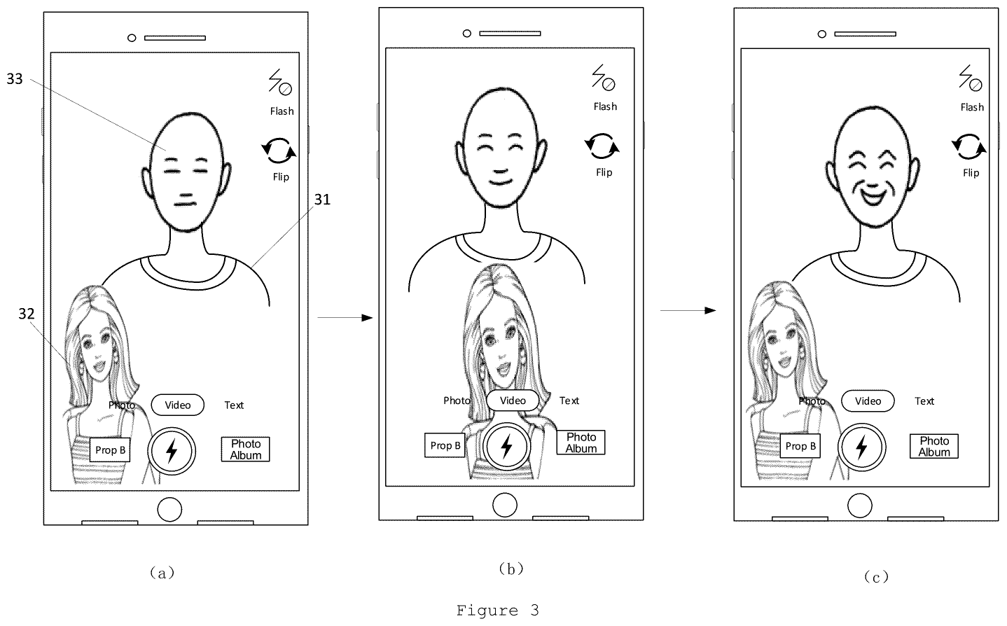

In an exemplary embodiment, the first image is a character image, as shown in FIG. 2, which is a schematic diagram of an interface of an electronic device for displaying a static character image. The electronic device may display a character image 21, which is a frame of a static image.
102: in response to an input for the first image, displaying a video including a plurality of consecutive frames of second images, to present a target object image acquired in real time and a dynamic effect of a local feature in the first image;
wherein by displaying the video including the plurality of consecutive frames of second images, it is possible to present the target object image acquired in real time and the dynamic effect of the local feature in the first image;
wherein each frame of the second images includes the target object image and a partial image of a third image, the third image being one frame of a plurality of consecutive frames of target images obtained after processing the local feature in the first image.

Optionally, the input for the first image may be a user's touch input on a screen displaying the first image when the electronic device displays the first image; the input for the first image may also be an input of a user shaking the electronic device when the electronic device displays the first image; the input for the first image may also be an input of selecting an image effect prop for the first image when the electronic device displays the first image, and by triggering the prop B, the first image is processed by the video display method provided in the embodiments of the present disclosure, and a generated video is displayed.

In an exemplary embodiment, as shown in FIG. 2, the electronic device can display a prop selection interface 22 when displaying the first image. In the prop selection interface 22, the user can select the prop B from image effect props. By selecting the prop B, the processing for the character image 21 using the video display method provided in the embodiments of the present disclosure is triggered, and a generated video is displayed.

Further, FIG. 3 is a schematic diagram of a plurality of frames of images in a video displayed in an embodiment of the present disclosure. After processing the character image 21 by selecting the prop B in FIG. 2, it is possible to display a video including three frames of images including (a) in FIG. 3, (b) in FIG. 3, and (c) in FIG. 3, wherein the three frames of images of (a) in FIG. 3, (b) in FIG. 3 and (c) in FIG. 3 each comprise a partial image 31 of the character image 21 as shown in FIG. 2, and further comprise another character image 32 acquired by a camera in real time. It can be seen that in the images of three frames of (a) in FIG. 3, (b) in FIG. 3 and (c) in FIG. 3, in the partial images 31, there is a change in the facial feature 33 in the character image, and the facial feature 33 in these partial images 31 is obtained after processing the facial feature of the character image 21 as shown in FIG. 2.

The video display method provided in the embodiments of the present disclosure can trigger the display of a video including a plurality of consecutive frames of second images by an input for a first image that is a static image, and since each frame of the second images includes a target object image and a partial image of a third image (one frame of a plurality of consecutive frames of target images obtained after processing a local feature in the first image), it is possible to present the dynamic effect of the local feature in the first image and the target object image acquired in real time by displaying the video, thereby concurrently presenting the dynamic effect of the static image and the real-time image acquired by a camera.

In some embodiments, each frame of the second images described above includes: a partial image of the first image, a partial image of the third image, and the target object image; wherein the third image is one frame of a plurality of consecutive frames of target images obtained after processing a local feature in the first image, and the partial image of the third image may be an image of the local feature portion in the third image (referred to as a first local image in the embodiments of the present disclosure). That is to say, each frame of the second images includes: a partial image of the first image, a first local image, and the target object image, wherein the first local image is displayed at the position of the local feature in the second image.

In the above embodiments, the partial image of the first image may or may not include the local feature portion. When the partial image of the first image includes the local feature portion, the partial image of the first image and the first local image are displayed through different layers, and by using a sticking manner, the local feature portion in the partial image of the first image is displayed at the position of the local feature in the second image, and the first local image is also displayed at the position of the local feature in the second image, so that the first local image can overlay the local feature portion in the partial image of the first image, forming an image including a processed local feature. When the partial image of the first image does not include the local feature portion, the first local image is displayed at the position of the local feature in the second image, so that the first local image and the partial image of the first image form a complete image including the local feature portion.

The above implementation likewise can present the dynamic effect of the local feature in the first image, and the target object image acquired in real time, thereby concurrently presenting the dynamic effect of the static image and the real-time image acquired by a camera.

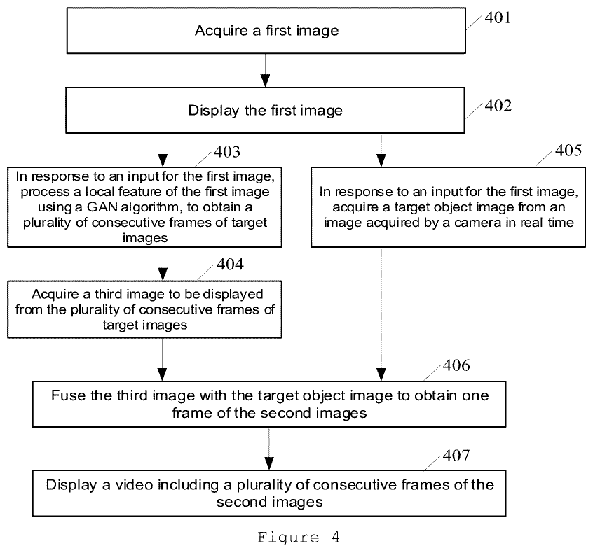

FIG. 4 shows a video display method provided in an embodiment of the present disclosure, the method comprising:
401: acquiring a first image.
402: displaying the first image.

In some embodiments, prior to the acquiring the first image, it is also possible to acquire a second image, and process a local feature of the second image using a GAN algorithm, to obtain and cache a plurality of consecutive frames of processed images.

The second image is a static image. In the embodiments of the present disclosure, for the static image acquired, in order to present a dynamic effect of the local feature, the GAN algorithm can be used to process the local feature in the second image to obtain and cache a plurality of consecutive frames of processed images.

After caching the plurality of consecutive frames of images obtained after processing the second image, if the first image described above is acquired, it can be determined whether the first image is the same as the second image, and if they are different, it is indicated that the image to be processed (the image of which the local feature is to be processed) has been replaced, and at this time, the plurality of consecutive frames of images obtained after processing the second image in a cache can be cleared, and processing can be re-performed for the first image.

In the above implementation, the images obtained after processing the local feature can be cached, and when the new image to be processed is acquired, the cache can be cleared in time; thus, it is ensured that a cache space will not be occupied by invalid data.

The video display method provided in the embodiments of the present disclosure, after acquiring the static image (i.e., the first image), can configure two algorithmic processing processes, wherein one is a processing process of processing the static image using the GAN algorithm, to obtain the dynamic effect of a local feature, as described in the following step 403 and step 404; and the other is a processing process of acquiring an image by a camera in real time and acquiring a target object image from the image acquired by the camera in real time using an image matting algorithm, as described in the following step 405. Moreover, the video display method finally fuses the results of the two algorithm processes to present the dynamic effect of the local feature in the first image, and the target object image acquired in real time.
403: in response to an input for the first image, processing a local feature of the first image using a GAN algorithm, to obtain a plurality of consecutive frames of target images.

In the embodiments of the present disclosure, processing the image using the GAN algorithm may be establishing a neural network model by the GAN and training the neural network model based on sample information. The sample information includes: a large number of original images containing local features, and standard images after local feature processing respectively corresponding to each original image; the original images containing local features in the sample information can be input into the neural network model established by the GAN to acquire output images, and the output images are compared with corresponding standard images to update the neural network model established by the GAN. Such training process is performed multiple times until the neural network model converges, and then the neural network model can be utilized to process the first image described above to obtain the plurality of consecutive frames of target images.

Optionally, in the embodiments of the present disclosure, the local feature may also be changed by adjusting the positions of feature key points corresponding to the local feature in the first image. In this way, it is also possible to obtain the plurality of consecutive frames of target images. For example, the first image is a character image, and positional adjustments can be made to some feature key points corresponding to the mouth in the character image (e.g., points corresponding to the corners of the mouth, and points on the edge of the lips), so that the display state of the mouth in the image is changed and different facial expressions are presented.

In some embodiments, the above plurality of consecutive frames of target images are complete images obtained after processing the local feature of the first image using the GAN, that is to say, the image after the processing using the GAN algorithm includes both a processed local feature image and an image of features in the first image other than the local feature.

In some embodiments, processing a local feature of the first image using a GAN algorithm to obtain the plurality of consecutive frames of target images comprises: first processing the local feature of the first image using the GAN algorithm to obtain a plurality of consecutive frames of local feature images, and then respectively fusing the first image with each of the plurality of consecutive frames of local feature images to obtain the plurality of consecutive frames of target images.

The rendering process of fusing the first image with one local feature frame of the plurality of consecutive frames of local feature images is as follows:
the first image is rendered through a first camera component to obtain a render texture of the first image; one frame of the plurality of consecutive frames of local feature images is rendered in a second camera component to obtain a render texture of the local feature image; and the render texture of the first image and the render texture of the one frame of the local feature images are combined to form one render texture, i.e., a render texture of one frame of the target images is obtained; wherein the first camera component and the second camera component may be components created in a rendering engine for performing image rendering.

The layer corresponding to the second camera component is located over the layer corresponding to the first camera component, and thus, after the render texture of the first image and the render texture of the one frame of the local feature images are combined to form one render texture, the local feature portion of the one frame of the target images is displayed as the one frame of the local feature images. Since the rendering process of fusing the first image with each of the plurality of consecutive frames of local feature images is the same, it is not repeated here.

In the above embodiment, the plurality of frames of local feature images obtained after processing using the GAN algorithm include only a processed local feature image and does not include an image of features in the first image other than the local feature.
404: acquiring a third image to be displayed from the plurality of consecutive frames of target images.

In some embodiments, the above 404 may be realized by the following steps:
404a: acquiring one frame of the target images to be displayed from the plurality of consecutive frames of target images.

Since the one frame of the target images to be displayed may not match well with a screen of an electronic device, and when directly rendering the rendering texture of the one frame of the target images and displaying it on the screen, the content in the one frame of the target images may be displayed either too large or too small, screen adaptation needs to be performed first.
404b: in accordance with an aspect ratio of the one frame of target images and a screen aspect ratio, constructing a Model View Projection (MVP) matrix.

In the embodiments of the present disclosure, a ratio of the aspect ratio of the one frame of target images to the screen aspect ratio may be calculated, and the MVP matrix may be constructed based on the ratio.
404c: in accordance with the MVP matrix, scaling the one frame of the target images to obtain a third image.

A patch of the third image to be displayed may be determined based on the MVP matrix and a patch of the one frame of the target images, and a camera component in a rendering engine can be used to perform rendering on the patch of the third image to obtain a rendering texture of the third image.
405: in response to an input for the first image, acquiring a target object image from an image acquired by a camera in real time.

In the embodiments of the present disclosure, an image matting algorithm may be used to segment the image acquired by the camera in real time into the target object image and an image of other portions, and the target object image can be extracted by a matting method.

In some embodiments, if the target object image is an image including a human face, after acquiring the target object image from the image acquired by the camera in real time, a preset beautifying algorithm can be used to process the target object image to obtain a target object image with a beautified effect.
406: fusing the third image with the target object image to obtain one frame of the second images.

In some embodiments, a mask image may first be determined in accordance with the image acquired by the camera in real time, and a first mask region corresponding to the target object image is identified in the mask image; in the mask image, the first mask region is identified by a target color channel; and then the target object image may be acquired from the image acquired by the camera in real time based on the mask image and the image acquired by the camera in real time, and finally according to the mask image and the third image, a partial image of the third image that matches other mask regions is obtained from the third image, and in accordance with the target object image and the partial image of the third image, one frame of the second images is formed by fusion.

The target color channel is any one of an R channel, a G channel, and a B channel.

That is, in the process of obtaining the one frame of the second images, it is needed to obtain the mask image for the image acquired by the camera in real time, the target object image and the third image, and to determine, based on the mask image, a display position of the target object image in the image to be displayed, and to determine, based on the mask image, which portions of the third image are to be displayed in the image to be displayed, as well as the display positions thereof. In the specific rendering process, it is needed to obtain the rendering texture of the third image and the rendering texture of the target object image, and to fuse the two portions of the rendering textures through the mask image described above, to obtain the final rendering texture of the one frame of the second images.
407: displaying a video including a plurality of consecutive frames of the second images.

In the embodiments of the present disclosure, the video display method provided achieves a dynamic effect of a local feature in a static image by processing the static image using a GAN algorithm, and by using an image matting algorithm, fuses images after processing using the GAN algorithm with a target object image acquired by a camera in real time to thereby obtain a video that can include the dynamic effect of the local feature in the static image, and the target object image acquired in real time, thereby concurrently presenting the dynamic effect of the static image, and the real-time image acquired by the camera.

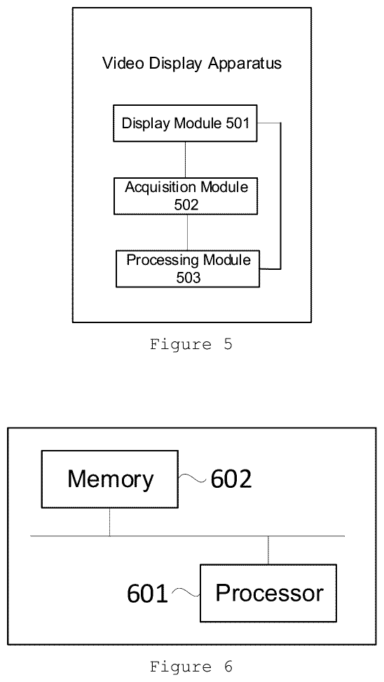

As shown in FIG. 5, there is provided a video display apparatus in an embodiment of the present disclosure, the apparatus comprising:
a display module 501 for displaying a first image; in response to an input for the first image, displaying a video including a plurality of consecutive frames of second images, to present a target object image acquired in real time and a dynamic effect of a local feature in the first image;
wherein each frame of the second images includes the target object image and a partial image of a third image, the third image being one frame of a plurality of consecutive frames of target images obtained after processing the local feature in the first image.

As an optional embodiment of the embodiments of the present disclosure, the apparatus further comprises:
an acquisition module 502 for acquiring the first image;
a processing module 503 for processing the local feature of the first image using a GAN algorithm, to obtain the plurality of consecutive frames of target images;
the acquisition module 502 further used to acquire the third image to be displayed from the plurality of consecutive frames of target images;
the processing module 503 further used to acquire the target object image from an image acquired by a camera in real time; and
the processing module 503 further used to fuse the third image with the target object image to obtain one frame of the second images.

As an optional embodiment of the embodiments of the present disclosure, the processing module 503 is specifically used to:
process the local feature of the first image using the GAN algorithm, to obtain a plurality of consecutive frames of local feature images; and
respectively fuse the first image with each of the plurality of consecutive frames of local feature images to obtain the plurality of consecutive frames of target images.

As an optional embodiment of the embodiments of the present disclosure, the processing module 503 is further used to:
in accordance with the image acquired by the camera in real time, determine a mask image in which a first mask region corresponding to the target object image is identified;
the processing module 503 is specifically used to:
in accordance with the mask image and the image acquired by the camera in real time, acquire the target object image from the image acquired by the camera in real time;
in accordance with the mask image and the third image, acquire, from the third image, a partial image of the third image that matches mask regions other than the first mask region; and
in accordance with the target object image and the partial image of the third image, form the one frame of the second images by fusion.

As an optional embodiment of the embodiments of the present disclosure, in the mask image, the first mask region is identified by a target color channel;
wherein the target color channel is any one of an R channel, a G channel and a B channel.

As an optional embodiment of the embodiments of the present disclosure, the acquisition module 502 is specifically used to:
acquire one frame of the target images to be displayed from the plurality of consecutive frames of target images;
in accordance with an aspect ratio of the one frame of target images and a screen aspect ratio, construct a Model View Projection (MVP) matrix; and
in accordance with the MVP matrix, scale the one frame of the target images to obtain the third image.

As an optional embodiment of the embodiments of the present disclosure, the acquisition module 502 is further used to acquire a second image;
the processing module 503 is further used to process the second image using the GAN algorithm, to obtain and cache a plurality of consecutive frames of processed images; and
the acquisition module 502 is further used to: in response to determining that the first image is different from the second image, clear the cache.

As shown in FIG. 6, there is provided an electronic device in an embodiment of the present application, the electronic device comprising: a processor 601, a memory 602, and a computer program stored on the memory 602 and executable on the processor 601 that, when executed by the processor, implements the respective steps of the video display method in the above method embodiments, and the same technical effect can be achieved. In order to avoid repetition, the method is not described here.

An embodiment of the present disclosure provides a computer readable storage medium storing a computer program thereon, which, when executed by a processor, implements the respective steps of the video display method in the above method embodiments, and the same technical effect can be achieved. In order to avoid repetition, the method is not described here.

The computer readable storage medium may be a Read-Only Memory (ROM), a Random Access Memory (RAN), a disk or an optical disk.

An embodiment of the present disclosure provides a computer program product storing a computer program which, when executed by a processor, implements the respective steps of the video display method in the above method embodiments, and the same technical effect can be achieved. In order to avoid repetition, the method is not described here.

It shall be understood by those skilled in the art that the embodiments of the present disclosure may be provided as a method, a system, or a computer program product. Therefore, the embodiments of the present disclosure can take the form of an entirely hardware embodiment, an entirely software embodiment or an embodiment containing both hardware and software aspects. Moreover, the present disclosure can be in a form of one or more computer program products containing the computer-executable codes which can be implemented on the computer-executable storage medium.

In the present disclosure, the processor may be a Central Processing Unit (CPU), or it may be other general-purpose processor, a Digital Signal Processor (DSP), an Application Specific Integrated Circuit (ASIC), a Field-Programmable Gate Array (FPGA), or other programmable logic device, discrete gate or transistor logic device, discrete hardware component, or the like. The general-purpose processor may be a microprocessor or the processor may also be any conventional processor, etc.

In the present disclosure, the memory may include a volatile memory in a computer readable medium, a random access memory (RAM) and/or non-volatile memory, and the like (e.g., a read-only memory (ROM) or a flash memory (flash RAM)). The memory is an example of a computer readable medium.

In the present disclosure, the computer readable medium includes volatile and non-volatile, and removable and non-removable storage media. The storage medium may implement information storage by any method or technique, and the information may be computer readable instructions, data structures, program modules, or other data. Examples of the computer storage medium include, but are not limited to, phase-change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disc-read-only memory (CD-ROM), digital versatile disk (DVD) or other optical storage, magnetic cassettes, magnetic disk storage or other magnetic storage device, or any other non-transmission medium that can be used to store information that can be accessed by computing devices. As defined herein, the computer readable medium does not include transitory computer readable media (transitory media), such as modulated data signals and carriers.

It is to be noted that terms used herein to describe relations such as “a first” and “a second” are only used to distinguish one entity or operation from another, but shall not require or suggest that these entities or operations have such an actual relation or sequence. Furthermore, the term “comprising”, “including” or any other variable intends to cover other nonexclusive containing relations to ensure that a process, method, article or apparatus comprising a series of factors comprises not only those factors but also other factors not explicitly listed, or further comprises factors innate to the process, method, article or apparatus. Without more limitations, a factor defined with the sentence “comprising one . . . ” does not exclude the case that the process, method, article or apparatus comprising said factor still comprises other identical factors.

The above are only specific embodiments of the present disclosure, which are used to enable those skilled in the art to understand or implement the present disclosure. Various modifications to the disclosed embodiments will be readily apparent to those skilled in the art. The general principles defined herein may be applied to other embodiments without departing from the spirit and scope of the present disclosure. Thus, the present invention will not be limited to the embodiments described herein, but is to be accorded the broadest scope consistent with the principles and novel features disclosed herein.

1. A video display method, comprising:
displaying a first image; and
in response to an input for the first image, displaying a video including a plurality of consecutive frames of second images, to present a target object image acquired in real time and a dynamic effect of a local feature in the first image;
wherein each frame of the second images includes the target object image and a partial image of a third image, the third image being one frame of a plurality of consecutive frames of target images obtained after processing the local feature in the first image.

2. The method according to claim 1, further comprising:
acquiring the first image;
processing the local feature of the first image using a Generative Adversarial Networks algorithm, to obtain the plurality of consecutive frames of target images;
acquiring the third image to be displayed from the plurality of consecutive frames of target images;
acquiring the target object image from an image acquired by a camera in real time; and
fusing the third image with the target object image to obtain one frame of the second images.

3. The method according to claim 2, wherein the processing the local feature of the first image using the Generative Adversarial Networks algorithm to obtain the plurality of consecutive frames of target images comprises:
processing the local feature of the first image using the Generative Adversarial Networks algorithm, to obtain a plurality of consecutive frames of local feature images; and
respectively fusing the first image with each of the plurality of consecutive frames of local feature images to obtain the plurality of consecutive frames of target images.

4. The method according to claim 2, wherein prior to the fusing the third image with the target object image to obtain one frame of the second images, the method further comprises:
in accordance with the image acquired by the camera in real time, determining a mask image in which a first mask region corresponding to the target object image is identified;
the acquiring the target object image from the image acquired by the camera in real time, comprising:
in accordance with the mask image and the image acquired by the camera in real time, acquiring the target object image from the image acquired by the camera in real time;
the fusing the third image with the target object image to obtain one frame of the second images, comprising:
in accordance with the mask image and the third image, acquiring, from the third image, a partial image of the third image that matches mask regions other than the first mask region; and
in accordance with the target object image and the partial image of the third image, forming the one frame of the second images by fusion.

5. The method according to claim 4, wherein in the mask image, the first mask region is identified by a target color channel;
wherein the target color channel is any one of an R channel, a G channel and a B channel.

6. The method according to claim 2, wherein the acquiring the third image to be displayed from the plurality of consecutive frames of target images comprises:
acquiring one frame of the target images to be displayed from the plurality of consecutive frames of target images;
in accordance with an aspect ratio of the one frame of target images and a screen aspect ratio, constructing a Model View Projection matrix; and
in accordance with the Model View Projection matrix, scaling the one frame of the target images to obtain the third image.

7. The method according to claim 2, further comprising:
acquiring a second image; and
processing the second image using the Generative Adversarial Networks algorithm, to obtain and cache a plurality of consecutive frames of processed images; and
subsequent to the acquiring the first image, the method further comprising:
in response to determining that the first image is different from the second image, clearing the cache.

8. (canceled)

9. An electronic device, comprising: a processor, a memory and a computer program stored on the memory and executable on the processor that, when executed by the processor, implements the video display method comprising:
displaying a first image; and
in response to an input for the first image, displaying a video including a plurality of consecutive frames of second images, to present a target object image acquired in real time and a dynamic effect of a local feature in the first image;
wherein each frame of the second images includes the target object image and a partial image of a third image, the third image being one frame of a plurality of consecutive frames of target images obtained after processing the local feature in the first image.

10. A non-transitory computer readable storage medium, comprising: a computer program stored on the computer readable storage medium that, when executed by a processor, implements the video display method comprising:
displaying a first image; and
in response to an input for the first image, displaying a video including a plurality of consecutive frames of second images, to present a target object image acquired in real time and a dynamic effect of a local feature in the first image;
wherein each frame of the second images includes the target object image and a partial image of a third image, the third image being one frame of a plurality of consecutive frames of target images obtained after processing the local feature in the first image.

11-12. (canceled)

13. The electronic device according to claim 9, wherein the video display method further comprises:
acquiring the first image;
processing the local feature of the first image using a Generative Adversarial Networks algorithm, to obtain the plurality of consecutive frames of target images;
acquiring the third image to be displayed from the plurality of consecutive frames of target images;
acquiring the target object image from an image acquired by a camera in real time; and
fusing the third image with the target object image to obtain one frame of the second images.

14. The electronic device according to claim 13, wherein the processing the local feature of the first image using the Generative Adversarial Networks algorithm to obtain the plurality of consecutive frames of target images comprises:
processing the local feature of the first image using the Generative Adversarial Networks algorithm, to obtain a plurality of consecutive frames of local feature images; and
respectively fusing the first image with each of the plurality of consecutive frames of local feature images to obtain the plurality of consecutive frames of target images.

15. The electronic device according to claim 13, wherein prior to the fusing the third image with the target object image to obtain one frame of the second images, the video display method further comprises:
in accordance with the image acquired by the camera in real time, determining a mask image in which a first mask region corresponding to the target object image is identified;
the acquiring the target object image from the image acquired by the camera in real time, comprising:
in accordance with the mask image and the image acquired by the camera in real time, acquiring the target object image from the image acquired by the camera in real time;
the fusing the third image with the target object image to obtain one frame of the second images, comprising:
in accordance with the mask image and the third image, acquiring, from the third image, a partial image of the third image that matches mask regions other than the first mask region; and
in accordance with the target object image and the partial image of the third image, forming the one frame of the second images by fusion.

16. The electronic device according to claim 15, wherein in the mask image, the first mask region is identified by a target color channel;
wherein the target color channel is any one of an R channel, a G channel and a B channel.

17. The electronic device according to claim 13, wherein the acquiring the third image to be displayed from the plurality of consecutive frames of target images comprises:
acquiring one frame of the target images to be displayed from the plurality of consecutive frames of target images;
in accordance with an aspect ratio of the one frame of target images and a screen aspect ratio, constructing a Model View Projection matrix; and
in accordance with the Model View Projection matrix, scaling the one frame of the target images to obtain the third image.

18. The electronic device according to claim 13, wherein the video display method further comprises:
acquiring a second image; and
processing the second image using the Generative Adversarial Networks algorithm, to obtain and cache a plurality of consecutive frames of processed images; and
subsequent to the acquiring the first image, the video display method further comprises:
in response to determining that the first image is different from the second image, clearing the cache.

19. The non-transitory computer readable storage medium according to claim 10, wherein the video display method further comprises:
acquiring the first image;
processing the local feature of the first image using a Generative Adversarial Networks algorithm, to obtain the plurality of consecutive frames of target images;
acquiring the third image to be displayed from the plurality of consecutive frames of target images;
acquiring the target object image from an image acquired by a camera in real time; and
fusing the third image with the target object image to obtain one frame of the second images.

20. The non-transitory computer readable storage medium according to claim 19, wherein the processing the local feature of the first image using the Generative Adversarial Networks algorithm to obtain the plurality of consecutive frames of target images comprises:
processing the local feature of the first image using the Generative Adversarial Networks algorithm, to obtain a plurality of consecutive frames of local feature images; and
respectively fusing the first image with each of the plurality of consecutive frames of local feature images to obtain the plurality of consecutive frames of target images.

21. The non-transitory computer readable storage medium according to claim 19, wherein prior to the fusing the third image with the target object image to obtain one frame of the second images, the video display method further comprises:
in accordance with the image acquired by the camera in real time, determining a mask image in which a first mask region corresponding to the target object image is identified;
the acquiring the target object image from the image acquired by the camera in real time, comprising:
in accordance with the mask image and the image acquired by the camera in real time, acquiring the target object image from the image acquired by the camera in real time;
the fusing the third image with the target object image to obtain one frame of the second images, comprising:
in accordance with the mask image and the third image, acquiring, from the third image, a partial image of the third image that matches mask regions other than the first mask region; and
in accordance with the target object image and the partial image of the third image, forming the one frame of the second images by fusion.

22. The non-transitory computer readable storage medium according to claim 21, wherein in the mask image, the first mask region is identified by a target color channel;
wherein the target color channel is any one of an R channel, a G channel and a B channel.

23. The non-transitory computer readable storage medium according to claim 19, wherein the acquiring the third image to be displayed from the plurality of consecutive frames of target images comprises:
acquiring one frame of the target images to be displayed from the plurality of consecutive frames of target images;
in accordance with an aspect ratio of the one frame of target images and a screen aspect ratio, constructing a Model View Projection matrix; and
in accordance with the Model View Projection matrix, scaling the one frame of the target images to obtain the third image.
